(19) United States
(12) Patent Application Publication
(10) Pub. No.: US 2026/0369306 A1
(43) Pub. Date: Nov. 19, 2026

(54) DRIVE BAY CAGE

(71) Applicant: Aivres Systems Inc., San Jose, CA (US)

(72) Inventor: Wenchi Shen, New Taipei City (TW)

(21) Appl. No.: 19/208,325

(22) Filed: May 14, 2025

(51) Int. Cl. G11B 33/12; G11B 33/14

(52) U.S. Cl. CPC G11B 33/127; G11B 33/142

(57) ABSTRACT

A drive bay cage encloses a drive bay that can receive a plurality of storage drives. The drive bay cage can be assembled from a plurality of upright panels including a front heat dissipation panel and first and second lateral side panels. A drive backplane is included inside the drive bay cage. To align the storage drives to the drive backplane, a lower fixture plate defining a plurality of drive slots parallel with a depth direction of the drive bay cage is located in the drive bay. To install the storage drives, a cage lid is removable to access the drive bay from the upright direction.

### TECHNICAL FIELD

The present disclosure relates to computer server systems and more particularly to structures for accommodating storages devices within a computer chassis with improved accessibility and reinforced stability.

### BACKGROUND

Computer systems employed as data servers and communications servers for the internet or internal enterprise networks typically must include large amounts of permanent data storage embodied as hard drives. Hard drives can be provided as hard disk drives (HDD) that include a magnetic metal or plastic disk contained in a drive cassette and that can have data magnetically written to or read from a rotating disk moving with respect to a magnetic head. Hard drives are also available as solid state drives (SSD) that are integrated circuits utilizing solid state memory technology to store data. The hard drives are available in standardized form factors such as 2.5 inch and 3.5 inch drives to simplify their incorporation into the computer systems produced by different manufacturers.

To increase storage, a plurality of hard drives can be bundled together into a drive module or data pack for installation into the computer system. The chassis or external case of the computer system may be configured with one or more drive bays, which are the standardized area for adding storage drives and other hardware. The term drive bay may refer to the area configured to contain one or more storage drives and each drive bay may be comprised of a plurality individual drive slots configured to hold individual storage drives. The dimensions of the drive bay are standardized for compatibility.

When drive bays are included in the computer system, the compartmental area of the drive bay can be structurally defined by a drive bay cage. The drive bay cage is typically built from panels of sheet or plate metal joined together to provide a box-like structure for accommodating the storage drives. The drive bay cage is often configured with features to facilitate insertion and removal of individual storage drives for replacement or upgrading. The drive bay cage may be preassembled and incorporated into the larger computer system.

### SUMMARY OF THE DISCLOSURE

A drive bay cage for accommodating a plurality of storage drive is assembled from a cage floor, a front heat dissipation panel perpendicular to the cage floor in an upright direction; and a pair of lateral side panels each extending perpendicular from the cage floor in the upright direction and orthogonal to the front heat dissipation panel. The plurality of upright panels connect together establish a drive bay. To secure the individual storage drives, a lower fixture plate disposed on the cage floor. The lower fixture plate define a plurality of drive slots extending a depth direction and laterally spaced from each other in longitudinal direction perpendicular to the drive direction. A drive backplane is located in the drive bay parallel to the front head dissipation panel perpendicular to the plurality of drive slots. Storage drives located in the drive slots are thereby aligned for connection with the drive backplane. To access the drive bay for insertion and removal of the storage drives, the drive bay cage includes a cage lid that may be removeably placed on the front heat dissipation panel and the first and second lateral side panels to parallel to the cage floor.

In a further aspect, each of the plurality of drive slots has a slot length configured to allow a storage drive to slide into an out of mating contact with the drive backplane.

In a further aspect, the lower fixture plate comprises a plurality of lateral supports aligned in the depth direction and spaced from each other with respect to each other in the longitudinal direction.

In a further aspect, the lower fixture plate comprises a lower support frame with a forward lower longitudinal bar and a rearward lower longitudinal bar parallel to the longitudinal direction and extending perpendicular to the plurality of lateral supports.

In a further aspect, the lower support frame includes a first lower lateral side bar and a second lower lateral side bar parallel to the lateral supports and extending perpendicular to the forward lower longitudinal bar and a rearward lower longitudinal bar.

In a further aspect, the front heat dissipation panel includes a plurality of venting frames establishing fluid communication with the drive bay.

In a further aspect, the plurality of venting frames each align with a respective one of the plurality of drive slots.

In a further aspect, the first lateral side panel and the second lateral side panel include fan unit arranged to establish airflow in the longitudinal direction.

In a further aspect, the cage lid comprises a lid vent that is oblong and that extends in the longitudinal direction traversing the plurality of drive slots.

In a further aspect, the cage lid comprise a plurality of lid handles for removing the cage lid from the drive bay cage.

In a further aspect, the lower fixture plate, the front heat dissipation panel, and the first and second lateral side panels are rigidly joined together.

The disclosure also provides a method of assembling a drive bay cage by providing a lower fixture plate defining a plurality of drive slots aligned with a depth direction. To produce a drive bay incorporating the drive slots, a front heat dissipation panel; a first lateral side panel, and a second lateral side panel are assembled to the lower fixture frame. The front heat dissipation panel, the first and second lateral side panels extend in an upright direction and are perpendicular to the depth direction. A drive backplane is installed into the drive bay in the upright direction and parallel to the front heat dissipation panel and perpendicular to the first and second lateral side panels. A storage drive is installed in one of the pluralities of drive slots by moving the storage drive in the upright direction into the drive slot and moving the storage drive in the depth direction to mate with the drive backplane. The drive bay can be enclosed by placing a cage lid on the front heat dissipation panel to releasably cover the storage drives.

In a further aspect, the lower fixture plate comprises a plurality of lateral supports aligned in the depth direction and spaced apart from each other with respect to a longitudinal direction perpendicular to the depth direction.’

In a further aspect, the plurality of lateral supports extending between a forward lower longitudinal bar and a rearward lower longitudinal bar each aligned parallel to the longitudinal direction.

In a further aspect, each of the first and second lateral side panels includes a fan unit arranged to establish airflow in the longitudinal direction.

In a further aspect the front heat dissipation panel includes a plurality of venting frames establishing fluid communication with the drive bay.

In a further aspect, each of the plurality of venting frames aligns with a respective one of the plurality of drive slots.

In a further aspect, the method includes assembling a rear heat dissipation panel parallel to the front heat dissipation panel and spaced apart from the front heat dissipation panel in the depth direction.

In a further aspect, the method includes fixedly joining the lower fixture plate, the front heat dissipation panel, and the first and second lateral side panels together with fasteners.

The disclosure also provides a drive bay cage that includes a cage floor, a front heat dissipation panel extending perpendicularly from the cage floor in an upright direction, and first and second lateral side panels each extending perpendicular from the cage floor in the upright direction and orthogonal to the front heat dissipation panel to establish a drive bay. To enclose the drive bay, a cage lid can be placed on the front heat dissipation panel and the first and second lateral side panels to parallel to the cage floor. The drive bay cage also includes a drive fixture assembly that comprises a lower fixture plate adjacent to the cage floor and an upper fixture plate adjacent to the cage lid. The upper fixture plates has an overhanging flange for abutting support one or more of the front heat dissipation panel, the first lateral side panel and the second lateral side panel.

### BRIEF DESCRIPTION OF THE DRAWINGS

FIG. 1 is a front perspective view of a drive bay cage designed in accordance with a prior art technique for accommodating a plurality of storage drives.

FIG. 2 is a rear perspective view of the conventional drive bay cage of FIG. 1 showing the fan bracket separated from the drive module.

FIG. 3 is a front perspective view of a drive bay cage assembled from a plurality of panels to establish a drive bay for accommodating storage drives designed in accordance with the disclosure.

FIG. 4 is an exploded assembly view of the components of the drive bay cages including front and rear heat dissipation panels, laterally-spaced side panels that may be associated with fan units, and a removable cage lid for accessing the drive bay.

FIG. 5 is an exploded assembly view of the components of a drive fixture assembly including a lower fixture plate defining a plurality of drive slots that are laterally spaced apart and aligned with the depth direction of the drive bay.

FIG. 6 is a detailed view of the area indicated in FIG. 3 of the perpendicular intersection of the heat dissipation panels and the lateral side panels rigidly joined by a corner bracket.

### DETAILED DESCRIPTION

The following detailed description is exemplary in nature and is not intended to limit the disclosure or the application and uses of the described embodiments. Furthermore, there is no intention to be bound by any expressed or implied theory presented in the preceding background, summary and brief description of the drawings, or the following detailed description. Numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

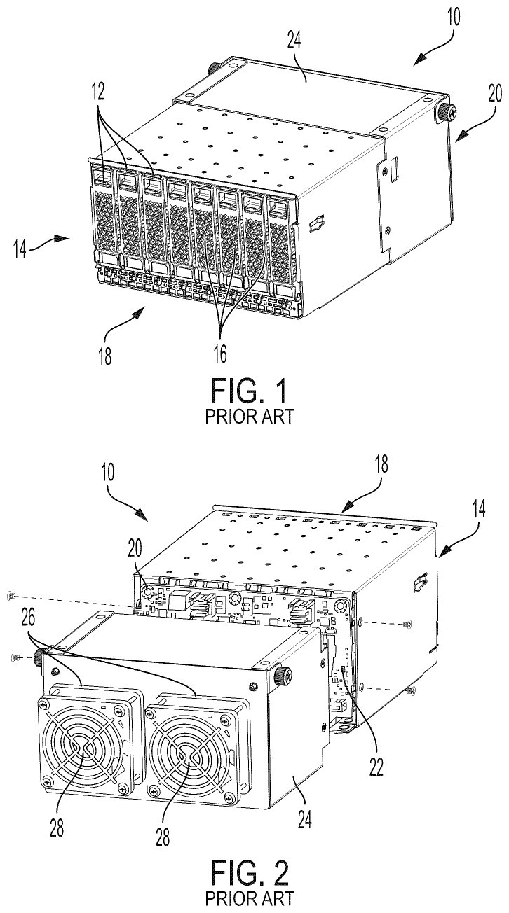

Referring to FIGS. 1 and 2, there is illustrated an embodiment of a drive bay cage 10. The drive bay cage 10 is a hollow structure configured to accommodate and fixate a plurality of storage drives in a particular location and orientation. For example, the illustrated drive bay cage 10 can establish a plurality of individual drive slots 12 that hold a corresponding plurality of individual storage drives each standing in a vertical arrangement and aligned horizontally. The drive slots 12 are accessible at the front face 14 of the drive bay cage 10. Each drive slot 12 is associated with a latch 16 at the front face 14 that is pivotally attached to the drive bay cage 10 that can pivot open to insert or remove a storage drive.

Drive slots 12 are aligned in an installation direction 18 that can be orthogonal to the front face 14 and that extends rearwardly toward a rear face 20 of the drive bay cage 10. The remaining faces of the drive bay cage 10 are provided by planar metal panels bent and pressed from sheet metal into an orthogonal box-like structure that encloses the drive slots 12. Although FIGS. 1 and 2 illustrates the plurality of drive slots 12 aligned horizontally in a row, the drive bay cage 10 can also be designed so that the individual drive slots are each horizontal and arranged in vertical stacks. By way of example, the drive slots can be configured to accommodate standard sized storage drives, such as 2.5 inch or 3.5 inch drives, which may be hard disk drives or solid state drives.

The drive bay cage 10 can include an internal drive backplane 22 which may be embodied as a planar printed circuit board oriented orthogonally to the insertion direction 18. The internal drive backplane 22 includes electrical connectors for establishing power and signal communication with the storage drives. For example, when the storage drives are inserted into the drive slots 12 through the front face 14 in the insertion direction 18, the storage drives can electrically mate with electrical connectors on the internal drive backplane 20. Spatially, the storage drives and the internal drive backplane 20 can be arranged in physical abutting contact and the latch 16 can be pivoted closed to urge the storage drives in the installation direction to maintain physical contact and the mating electrical connection between the components.

To dissipate the heat generated by the storage devices, the drive bay cage 10 can be associated with a fan module 24 that is attached oppositely of the front face 14 with respect to the installation direction. The fan module 24 includes a fan bracket 26 formed as a box-like structure that encloses one or more fan units 28. The fan bracket 26 aligns the fan units 28 to direct airflow along the installation direction 18 toward the front face 14. The generated airflow of course encounters the internal drive backplane 22 located between the drive bay cage 10 and the fan module 24. Therefore, the internal drive backplane 22 can include apertures allowing airflow to pass forwardly to the storage drives installed in the individual drive slots 12.

In the design of a drive bay cage 10, the internal drive backplane 22 and the corresponding mating connection with the storage drives is obstructed by the structure of the drive bay cage 10 and the fan module 24. Furthermore, because the drive slots 12 are aligned with the installation direction 18 and accessible only through the front face 14, visual observation of the electrical mating and connection between the storage drives and the internal drive backplane 22 is not possible.

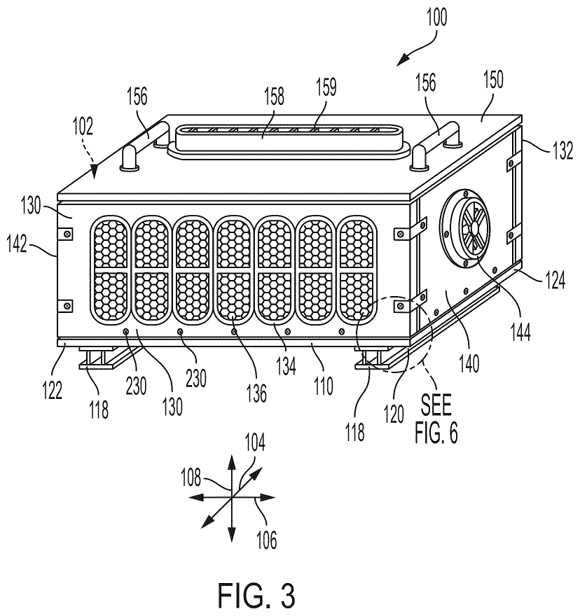

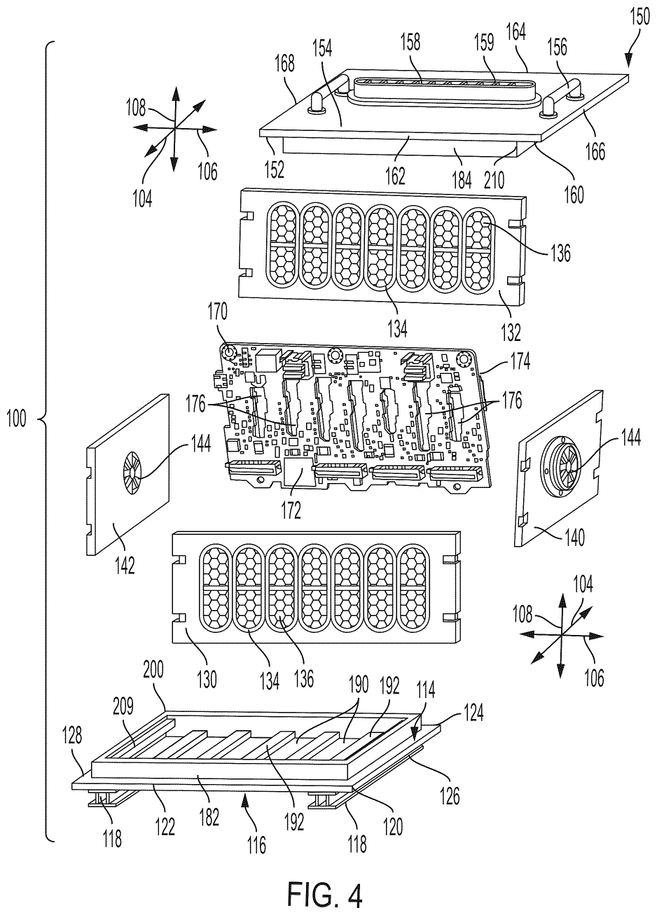

Referring to FIGS. 3 and 4, to improve accessibility and facilitate the installation of storage drives, a drive bay cage 100 is assembled in accordance with the disclosure to establish an installation process that allows visual observation of mating between the storage drives and drive backplane. For example, the drive bay cage 100 can be a box-like structure comprised of a plurality of orthogonally arranged panels that define and enclose a chamber-like space or drive bay 102 for accommodating a plurality of storage drives. The orthogonal arrangement establishes a referential coordinate system of different dimensions and directions including a depth direction 104 or a forward-rearward direction. Perpendicular to the depth-direction 104 is a longitudinal direction 106 that can be associated with lateral sides of the drive bay cage 100. Also perpendicular to the depth direction 104 and the longitudinal direction 106 can be a vertical or upright direction 108 that can be associated with the vertical height and elevation of the drive bay cage 100.

To establish the box-like structure, the drive bay cage 100 can be comprised of a plurality of planar panels and walls that are orthogonally arranged and joined together to enclose the drive bay 102. The planar panels can be made from metal plates or from molded plastics. For example, to structurally support the storage drives enclosed in the drive bay 102, the drive bay cage 100 can include a cage floor 110 that is shaped as a flat, planar plate. The planar flat shape of the cage floor 110 can be situated in the plane defined by the depth direction 104 and the longitudinal direction 106 that perpendicularly intersect each other. The flat planar shape of the cage floor 110 can establish an interior floor surface 114, oriented orthogonally to the upright direction to face the drive bay 102, and an exterior floor surface 116 that is opposite of the interior floor surface 114. As described below, the drive bay cage 100 can include support feet 118 that can be rail-like structures attached to the exterior floor surface 116.

The cage floor 110 can have a rectangular shape including a floor periphery 120 defining the overall orthogonal outline of the drive bay cage 100. In accordance with the rectangular shape, the floor periphery 120 can include forward and rearward longitudinal floor edges 122, 124 that are linear and parallel to each other and that are aligned with the longitudinal direction 106. The floor periphery 112 can also include first and second lateral side floor edges 126, 128 that are linear and extend perpendicularly between the forward and rearward longitudinal floor edges 122, 124 and that are aligned depth direction 104. While the floor periphery 120 is rectangular as illustrated, in other embodiments, the shape of the floor periphery 120 may be different with different dimensional extensions in the depth direction 104 and longitudinal direction 106.

To establish the front or forward face, the drive bay cage 100 includes a front heat dissipation panel 130 that can be a flat, planar structure. When the drive bay cage 100 is assembled, the front heat dissipation panel 130 can be oriented in the upright direction 108 perpendicular to the cage floor 110 and can be aligned with the longitudinal direction 106. In an embodiment, to establish the rearward face of the drive bay cage 100, a rear heat dissipation panel 132 can also be included that is parallel and spatially opposite of the front heat dissipation panel 130 with respect to the depth direction 104.

When the drive bay cage 100 is installed in a computer system such as a server, the front heat dissipation panel 130 can correspond in location with one of the front or rear panels of the chassis or computer case and the rear heat dissipation panel 132 may be exposed to the interior of the computer system. Due to their relatively exposed locations, the front and rear heat dissipation panels 130, 132 can be configured to establish fluid communication with the drive bay 102 inside the drive bay cage 100. For example, the front and rear heat dissipation panels 130, 132 can include a plurality of venting frames 134 that are disposed therein. The venting frames 134 define the outline of an aperture or opening through the front and rear heat dissipation panels 130, 132 for the fluid passage of cooling air. Each venting frame 134 can accommodate and secure a vent filter 136, such as an air permeable net or mesh.

In the illustrated embodiment, the venting frame 134 can each be oval in shape and oriented in the vertical or upright direction 108 and the plurality of venting frames 134 can be aligned in the longitudinal direction 106 such that venting frames are laterally adjacent to each other. In other embodiments, the venting frames 134 can have different shapes and orientations. As explained more fully below, the number of the venting frame 134 can correspond with the number of storage drives for accommodation in the drive bay cage 100.

To laterally enclose the drive bay 102 at the longitudinal ends, the drive bay cage 100 can include a first lateral side panel 140 and an opposite second lateral side panel 142. The first and second lateral side panels 140, 142 are laterally spaced apart with respect to the longitudinal direction 106 and can be oriented orthogonally between the front and rear heat dissipation panels 130, 132. The first and second lateral side panels 140, 142 can be flat, planar structures that extend vertically in the upright direction 108. When the drive bay cage 100 is assembled, the first lateral side panel can be adjacently joined to the first lateral side floor edge 126 and the second lateral side panel 128 can be adjacently joined to the second lateral side floor edge 128.

To establish airflow into the drive bay 102 through the venting frames 134, the first and second lateral side panels 140, 142 can each be associated with a fan unit 144. The fan units 144 are motorized electrical devices having a plurality of rotating fan vanes or blades that displace air when moving. The fan units 144 can be oriented to direct airflow in the longitudinal direction 106 of the drive bay 102. To hold and fixedly situate the fan units 144, the first and second lateral side panel 140, 142 can include appropriately shaped cutouts and the fan units can be bolted thereto by fasteners. In some embodiments, the fan units 144 can be motionless and operate on electrostatic charging principles.

To access the drive bay 102, the drive bay cage 100 can include a cage lid 150 that is removeable. The cage lid 150 is a flat planar structure that is oriented orthogonally to the upright direction 108 and that is parallel to and vertically spaced above the cage floor 110. The cage lid 150 can also be similar in shape and dimensionally coextensive with the shape and size of the cage floor 110. When assembled, the cage lid 150 can abut and be situated on top of the upper edges of the front and rear heat dissipation panels 130, 132 and the first and second lateral side panels 140, 142 that are each vertically oriented in the upright direction 108.

When situated in place, the cage lid 150 has an interior lid surface 152 that is exposed to the drive bay 102 and an exterior lid surface 154 oppositely located with respect to the interior lid surface 152. To enable lifting and removal of the cage lid 150, one or more lid handles 156 are attached to the exterior lid surface 154 for accessibility. The lid handles 156 are shaped for grasping and manipulation by hand and may be configured as bent rods that project from the exterior lid surface 154 in the upright direction 108. In other configurations, the lid handles 156 can be structural depressions disposed into the structure of the cage lid 150 below the exterior lid surface 154 to maintain a low profile with respect to the upright direction 108.

In an embodiment, to allow for additional airflow into the drive bay 102 enclosed by the drive bay cage 100, the cage lid 150 can include a lid vent 158 that is disposed between the interior lid surface 152 and the exterior lid surface 154. The lid vent 158 can be oblong or oval in shape and may extend parallel with the longitudinal direction 106. In an embodiment, the lid vent 158 can include a plurality of dividers 159 aligned in the depth direction 104 and that separate the lid vent 158 into a plurality of laterally-spaced openings which may correspond with the number of storage drives to be accommodated within the drive bay 102.

To correspond to the rectangular shape of the cage floor 110, the cage lid 150 can have a lid periphery 160 that is similarly rectangular in shape. The lid periphery 160 can include forward and rearward longitudinal lid edges 162, 164 that are linear and parallel to each other and that are aligned with the longitudinal direction 106. The lid periphery 160 can also include first and second lateral side lid edges 166, 168 that are linear and extend perpendicularly between forward and rearward longitudinal lid edges 162, 164 and that are aligned with the depth direction 104. The lid periphery 160 can have different shapes, preferably that are commensurate in shape and dimension with the floor periphery 120.

The drive bay cage 100 can accommodate a drive backplane 170 to which the plurality of storage drives are electrically and physically connected. The drive backplane 170 establishes data and power electrical communication with the plurality of storage drives and can be configured as a planar printed circuit board. The planar shape of the drive backplane 170 can therefore have a first or forward planar surface 172 and a second or rearward planar surface 174 located opposite thereof. The drive backplane 170 can have electrical connectors and electrical devices mounted onto the forward and rearward planar surfaces 172, 174. The drive backplane 170 can be made of laminated layers of insulating material such as phenolic resin with conductive traces disposed therein.

When assembled in the drive bay cage 100, the drive backplane 170 is situated in the drive bay 102 parallel with and located between the front and rear heat dissipation panels 130, 132. To allow airflow between the front and rear heat dissipation panels 130, 132, the drive backplane 170 can include airflow passages 176 formed as cutouts and extending between the forward and rearward planar surfaces 172, 174. The drive backplane 170 can be oriented upright with respect to the upright direction 108 and can extend substantially between the first and second lateral side panels 140, 142. Power and data cables can be routed through an opening in the rear heat dissipation panel 132 to communicate with the drive backplane 170. In a possible embodiment, the drive backplane 170 may replace the rear heat dissipation panel 132 in the drive bay cage 100 as assembled.

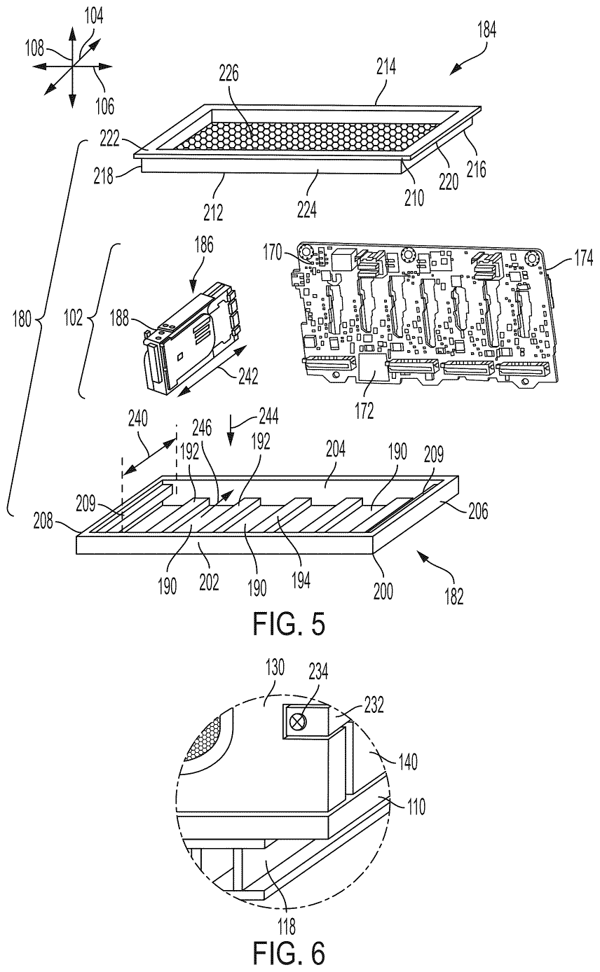

To align and support the plurality of storage drives for connection with the drive backplane 170, the drive bay cage 100 can be associated with a drive fixture assembly 180. Referring to FIG. 5, the drive fixture assembly 180 can include a first or lower fixture plate 182 and a second or upper fixture plate 184, which are provided as physically separate components spaced part from each other with respect to the vertical or upright direction 108. The lower and upper fixture plates 182, 184 can be arranged to sandwich and support a plurality of storage drives 186 aligned in a horizontal row corresponding to the longitudinal direction 106 with each storage drive standing vertically with respect to the upright direction 108.

The plurality of storage drives 186 can be grouped together to form a storage module which is commonly accommodated in the drive bay cage 100. The storage drives 186 can be hard disk drives or solid state drives. For protection, each storage drive 186 can be encased in a three-dimensional orthogonal drive cartridge that may be made of metal or plastic.

To align and accommodate each of the storage drives 186, the lower fixture plate 182 can define a plurality of drive slots 190 that are laterally spaced apart and aligned with the depth direction 108 of the drive bay cage. To correspond to the rectangular shape of the drive cartridges 188, each of the drive slots 190 can be rectangular in shape and may be aligned with the depth direction 104. In an embodiment, to structurally define the drive slots 190, the lower fixture plate 182 can include a plurality of lateral drive supports 192, each of which may be formed as a three-dimensional rectangular bar. For example, the lateral drive supports 192 can be cut from flat metal bar stock having a rectangular cross-section.

The lateral drive supports 192 are spaced apart in the longitudinal direction 106 to define the drive slots 190 between adjacent pairs of lateral drive supports. The lateral drive supports 192 can be commensurate in length with each other and, in an embodiment may each have a length that is longer than the corresponding length of the drive cartridge 188 with respect to the depth direction 104. Furthermore, the lateral drive supports 192 can be relatively flat and have a limited extension with respect to the upright direction 108. When the storage drives 186 are inserted into the drive slots 190, the lateral drive supports 192 are positioned adjacently on either side of the lower edge of the drive cartridge 188. The drive supports 192 function to brace and prevent lateral displacement of the storage drive 186 toward the sides with respect to the longitudinal direction 106.

To spatially fix the location and orientations of the lateral drive supports 192, the lower fixture plate 182 can include a lower support frame 200. The lower support frame 200 can have a generally rectangular outline comprised of rigid interconnected bars that surrounds and attaches to lateral drive supports 192. The lower support frame 200 can, for example, include a forward lower longitudinal bar 202 and a rearward lower longitudinal bar 204 that are linear and parallel to each other and that extend in the longitudinal direction 106 orthogonal with the depth direction 104. The forward and rearward lower longitudinal bars 202, 204 can be rectangular metal bar stock and may be slightly larger in dimension in the upright direction 108 than the lateral drive supports 192.

To interconnect and rigidly join the forward and rearward lower longitudinal bars 202, 204, the lower support frame 200 can include a first lower lateral side bar 206 and a second lower lateral side bar 208. The first and second lower lateral side bars 206, 208 can be linear and parallel to each other and can be aligned with the depth direction 108 perpendicular to the longitudinal direction 106. The first and second lower lateral side bars 206, 208 can be linear and parallel with the plurality of lateral drive supports 192 and the drive slots 190 located there between. The first and second lower lateral side bars 206, 208 can be made of the same bar stock as the forward and rearward lower longitudinal bars 202, 204.

In an embodiment, each of the first and second lower lateral side bars 206, 208 can include a limit bar 209 that is attached to an inward edge to be parallel with the depth direction 104. The limit bar 209 can be sized to fit and extend between the distal ends of the forward and rearward lower longitudinal bars 202, 204. The limit bars 209 can function as lateral side supports for the laterally outermost storage drives 186 that may be installed in the laterally outermost drive slots 190 formed by the lower fixture plate 182.

The spatial extension of the support frame 200 can be slightly smaller than the floor periphery 120. When the lower support frame 200 is mounted to the cage floor 110, the first and second lower lateral side bars 206, 208 may be spaced inwardly of the parallel forward and rearward lower longitudinal floor edges 122, 124 with respect to the depth direction 104. Likewise, the first and second lower lateral side bars 206, 208 are spaced inwardly of the parallel first and second lateral side floor edges 126, 128 with respect to the longitudinal direction 106. The inwardly spaced arrangement of those components defines right-angled interior corners that can receive the lower edges of the front and rear heat dissipation panels 130, 132 and the first and second lateral side panels 140, 142 when the drive bay cage 100 is assembled.

The upper fixture plate 184 can include an upper support frame 210 that corresponds to the rectangular shape of the lower support frame 200. To produce the rectangular shape, the upper support frame 210 can include corresponding forward and rearward upper longitudinal bars 212, 214 that are linear and parallel with the longitudinal direction 106 and that are interconnected by first and second upper lateral side bars 216, 218 that are linear and extend perpendicular to the longitudinal direction 106 and parallel with the depth direction 104. The dimensions of the upper support frame 210 in the depth direction 104 and the longitudinal direction 106 can match those of the lower support frame 200.

To support the upper fixture plate 184 vertically over and above the drive bay when assembled to the drive cage, the upper support frame 210 can include an overhanging flange, which in the illustrated embodiment is provided as first overhanging flange 220 and a second overhanging flange 222. The first overhanging flange 220 can be integrally formed and coextensive with the first upper lateral side bar 216 and the second overhanging flange 222 can be integrally formed and coextensive with the second upper lateral side bar 218 so that the overhanging flanges are perpendicular to the longitudinal direction 106. In other arrangements, the first and second overhanging flanges 220, 222 can be associated with, for example, the forward and rearward upper lateral side bars 216, 218 of the upper support frame 210.

The first and second overhanging flanges 220, 222 are coplanar with the uppermost surface of the upper support frame 210 with respect to the upright direction 108. The additional structure of the upper support frame 210 can form an alignment boss 224 that projects downward with respect to the upright direction 108 and that is set peripherally inward with respect to the first and second overhanging flanges 220, 222. The intersection of the first and second overhanging flanges 220, 222 and the alignment boss 224 creates a right-angled corner or step. When the upper fixture plate 184 is installed on the drive bay cage 100, the first and second overhanging flanges 220, 222 can abut the upper edges of the first and second lateral side panels 140, 142 to support the upper fixture plate 184 above the drive bay 102 in the upright direction 108. To allow airflow into the drive bay 102 through the lid vent 158, the upper frame plate 184 can include a vent filter 226, such as an air permeable net or mesh

Referring to FIGS. 3 and 4, to assemble the drive bay cage 100, the lower fixture support 182 can be placed adjacent to the cage floor 110 such that the plurality of drive slots 190 are aligned parallel with the depth direction 104. The front and rear heat dissipation panels 130, 132 and the first and second lateral side panels 140, 142 can be assembled to the cage floor 110 and the lower fixture plate 182 thereon such that each is vertically oriented in the upright direction 108. In particular, the front heat dissipation panel 130 can be adjacent and parallel with the forward lower longitudinal bar 202 of the lower support frame 200 and the rear heat dissipation panel 132 can be adjacent and parallel with the rearward lower longitudinal bar 204 of the lower support frame 200. Likewise, the first and second lateral side panels 140, 142 can be adjacent with the first and second lower lateral side bars 206, 208 of the lower support frame 200.

Fasteners can be used to rigidly connect the lower components of the drive bay cage 100 together to establish and enclose the drive bay 102. For example, referring to FIG. 3, a plurality of fasteners 230 can be installed proximately along the lower edge of the front heat dissipation panel 130 in the longitudinal direction 106 to secure the panel to the forward lower longitudinal bar 202 there behind. Fasteners 230 can be used to similarly fixedly connect the rearward heat dissipation panel 132 and the first and second lateral side panels 140, 142 to the respective components on the lower fixture plate 182. As an alternative to fasteners, an adhesive can be used to fixedly join the parts together.

Referring to FIG. 6, to rigidly secure the front and rear heat dissipation panels 130, 132 to the first and second lateral side panels 140, 142, a plurality of corner brackets 232 can be used to fixedly connect, for example, the front heat dissipation panel 130 to the first lateral side panel 140 at a perpendicular right angle. The rear heat dissipation panel 132 and the first and second lateral side panels 140, 142 can be similarly joined by corner brackets 232 so that the upright panels assumes an orthogonal arrangement, in which the drive bay 102 is defined. Additional fasteners 234 can be used to secure the corner brackets 232 to the front and rear heat dissipation panels 130, 132 to the first and second lateral side panels 140, 142.

Referring to FIGS. 4 and 5, the drive backplane 170 is installed in the drive bay 102 oriented in the upright direction 108 and parallel with the front and rear heat dissipation panels 130, 132. The drive backplane 170 therefore extends perpendicularly to the plurality of drive slots 190 defined in the lower fixture plate 182. The forward planar surface 172 can be oriented facing the front heat dissipation panel 130 and the rearward planar surface 174 can face the rear heat dissipation panel 132.

To install the storage drives 186, referring to FIG. 5, a storage drive 186 is aligned vertically above a corresponding one of the drive slots 190 parallel with the depth direction 104. Each of the drive slots 190 can have a slot depth 240 in the depth direction 104 which may be larger in dimension than a corresponding drive length 242 associated with the storage drive 186. Accordingly, when the storage drive 186 is moved downwardly in the upright direction 108 in a first installation direction indicated by arrow 244 toward the cage floor 110, the lower edge of the storage drive 186 can be received in the drive slot 190 defined by the lower fixture plate 182. The storage drive 186 can be situated between a pair of the lateral supports 192 defining the drive slot 190 and is fixed against lateral movement in the longitudinal direction 106.

To mate the storage drive 186 with the drive backplane 170, the storage drive 186 is moved in the depth direction 104 in a second installation direction indicated by arrow 246. The storage drive 186 moves rearwardly in the drive slots 190 between the pair of lateral drive supports 192 which may be sufficiently spaced to allow sliding motion in the depth direction. To align the storage drives 186 for mating connection, the drive slots 190 themselves can be aligned with corresponding mating connectors mounted to the forward planar surface 172 of the drive backplane 170. The lateral drive supports 192 function to slidingly guide the storage drives into contact with the drive backplane 170.

The difference between the slot depth 240 and the drive length 242 allows for relative motion of the storage drive 186 and the drive slots 190 in the second installation direction 246 until the storage drive 186 perpendicularly abuts the drive backplane 170. Similarly, the difference between the slot depth 240 and the drive length 242 allow for un-mating and removal of the storage drive 186 from the drive backplane 170 by motion in the opposite direction of the second installation direction 246.

When the plurality of storage devices 186 have been connected with drive backplane 170 inside the drive bay cage 100, the drive bay 102 can be enclosed by placing the cage lid 150 on top of the upper edges of the front and rear heat dissipation panels 130, 132 and the first and second lateral side panels 140, 142 that are orthogonally arranged. The upper fixture plate 184 can be first placed adjacent to the interior lid surface 152 of the cage lid 150 to be partially received in the drive bay 102. The upper fixture plate 184 can have structures to assist in orientating and fixating the internal components located inside the drive bay cage 100. The alignment boss 224 projecting from the upper fixture plate 184 downwardly in the upright direction 108 can received into the drive bay 102 by sliding with respect to the upper edges of the front and rear heat dissipation panels 130, 132 and the first and second lateral side panels 140, 142 thereby aligning the cage lid 150 with respect to the drive bay cage 100 and preventing the cage lid from sliding off.

In an embodiment, the cage lid 150 may be removable with respect to the drive bay cage 100. Specifically, the cage lid 150 can be loosely situated over the orthogonally connected front and rear heat dissipation panels 130, 132 and the first and second lateral side panels 140, 142 and supported by the overhanging flanges 220, 222. The removable arrangement contrasts with the rigidly fixed and joined configuration of the lower fixture plate 182 with the front and rear heat dissipation panels 130, 132 and the first and second lateral side panels 140, 142.

The cage lid 150 can be lifted in the upright direction 108 due to the removable arrangement to uncover the drive bay 102. Removing the cage lid 150 allows visual observation into the drive bay 102 from above in the upright direction 108 and in particular allows inspection of the mating connection between the storage drives 186 and the drive backplane 170. For example, because the direction of view into the drive bay 102 is along the upright direction 108 perpendicular to the depth direction 104 associated with the second installation direction 246, abutting contact between the drive backplane 170 and the storage drives 186 is unobstructed. The lid handles 156 can be grasped by hand to facilitate removal of the cage lid 150.

Referring to FIGS. 3 and 4, to reduce the heat generated by the storage drives inside the drive bay cage 100 when the cage lid 150 is closed, the fan units 144 disposed in the first and second lateral side panels 140, 142 can be activated creating airflow with respect to the drive bay 102. The plurality of vent frames 134 in the front heat dissipation panel 130 and/or the lid vent 158 in the cage lid 150 cooperate with the fan units 144 directing airflow fluidly into or out of the drive bay 102 enclosed in the drive bay cage 100.

In an embodiment, the plurality of vent frames 134 in the front and rear heat dissipation panels 130, 132 are position longitudinally traverse to the plurality of drive slots 190 disposed in the lower fixture plate 182 of the drive fixture assembly 180. Each vent frame 134 can therefore be operatively associated with a respective one of the storage drives located in the drive slots 190. The lid vent 158 also extends longitudinally traverse to plurality of drive slots 190 in the lower fixture plate 182 and is arranged to direct airflow in the upright direction onto the storage drives located in the drive slots 190 and perpendicular to depth direction 104. The dividers 159 of the lid vent 158 may correspond with individual drive slots 190.

To mount the drive bay cage 100 inside a computer system, the mounting feet 118 attached to the cage floor 110 can be attached to a panel inside the computer chassis. The mounting feet 118 can be rails that extend in the depth direction 104 as offset laterally toward the first and second lateral side panel 140, 142. In other embodiments, the mounting feed 118 can be vibration isolation mounts, or can be associated with such mounts, typically made of rubber or other elastic material to help stabilize the plurality of storage drives located in the drive bay cage 100.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A drive bay cage for accommodating a plurality of storage drives comprising:
a cage floor;
a lower fixture plate disposed on the cage floor, the lower fixture plate defining a plurality of drive slots extending in a depth direction and laterally spaced from each other in a longitudinal direction perpendicular to the depth direction;
a front heat dissipation panel extending perpendicularly from the cage floor in an upright direction;
a first lateral side panel and a second lateral side panel each extending perpendicular from the cage floor in the upright direction and orthogonal to the front heat dissipation panel to establish a drive bay;
a drive backplane located in the drive bay parallel to the front heat dissipation panel and perpendicular to the plurality of drive slots; and
a cage lid enclosing the drive bay by removable placement on the front heat dissipation panel and the first and second lateral side panels such that the cage lid is parallel to the cage floor.

2. The drive bay cage of claim 1, wherein each of the plurality of drive slots has a slot length configured to allow a storage drive to slide into and out of mating contact with the drive backplane.

3. The drive bay cage of claim 1, wherein the lower fixture plate comprises a plurality of lateral drive supports aligned in the depth direction and spaced apart with respect to each other in the longitudinal direction.

4. The drive bay cage of claim 3, wherein the lower fixture plate comprises a lower support frame with a forward lower longitudinal bar and a rearward lower longitudinal bar parallel to the longitudinal direction and extending perpendicular to the plurality of lateral drive supports.

5. The drive bay cage of claim 4, wherein the lower support frame comprises a first lower lateral side bar and a second lower lateral side bar parallel to the lateral drive supports and extending perpendicular to the forward lower longitudinal bar and a rearward lower longitudinal bar.

6. The drive bay cage of claim 1, wherein the front heat dissipation panel comprises a plurality of venting frames establishing fluid communication with the drive bay.

7. The drive bay cage of claim 6, wherein the plurality of venting frames each align with a respective one of the plurality of drive slots.

8. The drive bay cage of claim 1, wherein the first lateral side panel and the second lateral side panel each comprise a fan unit arranged to establish airflow in the longitudinal direction.

9. The drive bay cage of claim 1, wherein the cage lid comprises a lid vent that is oblong and extends in the longitudinal direction traversing the plurality of drive slots.

10. The drive bay cage of claim 1, wherein the cage lid comprise a plurality of lid handles for removing the cage lid from the drive bay cage.

11. The drive bay cage of claim 1, wherein the lower fixture plate, the front heat dissipation panel, and the first and second lateral side panels are rigidly joined together.

12. A method of assembling a drive bay cage comprising:
providing a lower fixture plate defining a plurality of drive slots aligned with a depth direction;
assembling a front heat dissipation panel, a first lateral side panel, and a second lateral side panel to the lower fixture frame, the front heat dissipation panel and the first and second lateral side panels extending in an upright direction and perpendicular to the depth direction to define a drive bay;
installing a drive backplane into the drive bay in the upright direction and parallel to the front heat dissipation panel and perpendicular to the first and second lateral side panels;
installing a storage drive in one of the plurality of drive slots by moving the storage drive in the upright direction into the drive slot and moving the storage drive in the depth direction to mate with the drive backplane; and
enclosing the drive bay by placing a cage lid on the front heat dissipation panel and parallel to the lower fixture plate to releasably cover the storage drive.

13. The method of claim 12, wherein the lower fixture plate comprises a plurality of lateral drive supports aligned in the depth direction and spaced apart from each other with respect to a longitudinal direction perpendicular to the depth direction.

14. The method of claim 13, wherein the plurality of lateral drive supports extend between a forward lower longitudinal bar and a rearward lower longitudinal bar that are each aligned parallel to the longitudinal direction.

15. The method of claim 12, wherein each of the first and second lateral side panels comprises a fan unit arranged to establish airflow in the longitudinal direction.

16. The method of claim 12, further comprising a plurality of venting frames in the front heat dissipation panel establishing fluid communication with the drive bay.

17. The method of claim 16 wherein each of the plurality of venting frames aligns with a respective one of the plurality of drive slots.

18. The method of claim 12, further comprising assembling a rear heat dissipation panel parallel to the front heat dissipation panel and spaced apart from the front heat dissipation panel in the depth direction.

19. The method of claim 12, further comprising fixedly joining the lower fixture plate, the front heat dissipation panel, and the first and second lateral side panels together with fasteners.

20. A drive bay cage comprising:
a cage floor;
a front heat dissipation panel extending perpendicularly from the cage floor in an upright direction;
a first lateral side panel and a second lateral side panel each extending perpendicular from the cage floor in the upright direction and orthogonal to the front heat dissipation panel to establish a drive bay;
a cage lid enclosing the drive bay by removable placement on the front heat dissipation panel and the first and second lateral side panels parallel to the cage floor; and
a drive fixture assembly comprising a lower fixture plate adjacent to the cage floor and an upper fixture plate adjacent to the cage lid; the upper fixture plate comprising an overhanging flange for abutting support on one or more of the front heat dissipation panel, the first lateral side panel, and the second lateral side panel.
